(19) United States
(12) Patent Application Publication
(10) Pub. No.: US 2015/0184828 A1
(43) Pub. Date: Jul. 2, 2015

(54) OPTICAL LENS AND LIGHT SOURCE MODULE HAVING THE SAME

(71) Applicant: HON HAI PRECISION INDUSTRY CO., LTD., New Taipei (TW)

(72) Inventors: FENG-YUEN DAI, New Taipei (TW); CHAU-JIN HU, New Taipei (TW); LI-YING WANG HE, New Taipei (TW)

(73) Assignee: HON HAI PRECISION INDUSTRY CO., LTD., New Taipei (TW)

(21) Appl. No.: 14/144,410

(22) Filed: Dec. 30, 2013

(30) Foreign Application Priority Data
Dec. 26, 2013 (TW) 102148564

(51) Int. Cl. F21V 5/04; F21K 99/00

(52) U.S. Cl. CPC F21V 5/045; F21K 9/58; F21Y 2101/02

(57) ABSTRACT

A light source module includes a light source and an optical lens facing the light source. The optical lens includes a light incident face facing the light source, a light emitting face opposite to the light incident face, and a connecting face connecting the light incident face and the light emitting face. The light emitting face comprises a lateral face extending upwardly from an outer periphery of the connecting face and a top face located above the light incident face. The top face of the light emitting face includes a center facet and a periphery facet surrounding and extending outwardly from the center facet. The center facet is recessed inwardly from a center of the top face of the light emitting face.

### BACKGROUND

1. Technical Field

The disclosure generally relates to optical lenses, and particularly relates to an optical lens to increase an illuminating angle of a light source and a light source module having the optical lens.

2. Description of Related Art

In recent years, due to excellent light quality and high luminous efficiency, light emitting diodes (LEDs) have increasingly been used as substitutes for incandescent bulbs, compact fluorescent lamps and fluorescent tubes as light sources of illumination devices.

Generally, light intensity of a light emitting diode gradually decreases from a middle portion to lateral sides thereof. Such a feature makes the LED unsuitable for functioning as a light source which needs a wide illumination, for example, a light source for a direct-type backlight module for a liquid crystal display (LCD). In some conditions, it is required to have an optical lens which can help the light emitted from a light emitting diode to have a wider illuminating angle and a special light distribution. Unfortunately, the conventional optical lens and a light source module having the conventional optical lens can not obtain a satisfactory effectiveness.

What is needed, therefore, is an improved optical lens and a light source module having the optical lens to overcome the above described disadvantages.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an isometric view of an optical lens in accordance with an exemplary embodiment of the present disclosure.

FIG. 2 is an inverted view of the optical lens in FIG. 1.

FIG. 3 is a cross section view of the optical lens in FIG. 1, taken along a line III-III thereof, wherein a light source is positioned in the optical lens.

FIG. 4 shows a light distribution of a light source module having the optical lens of FIG. 1.

### DETAILED DESCRIPTION

Embodiments of an optical lens and a light source module will now be described in detail below and with reference to the drawings.

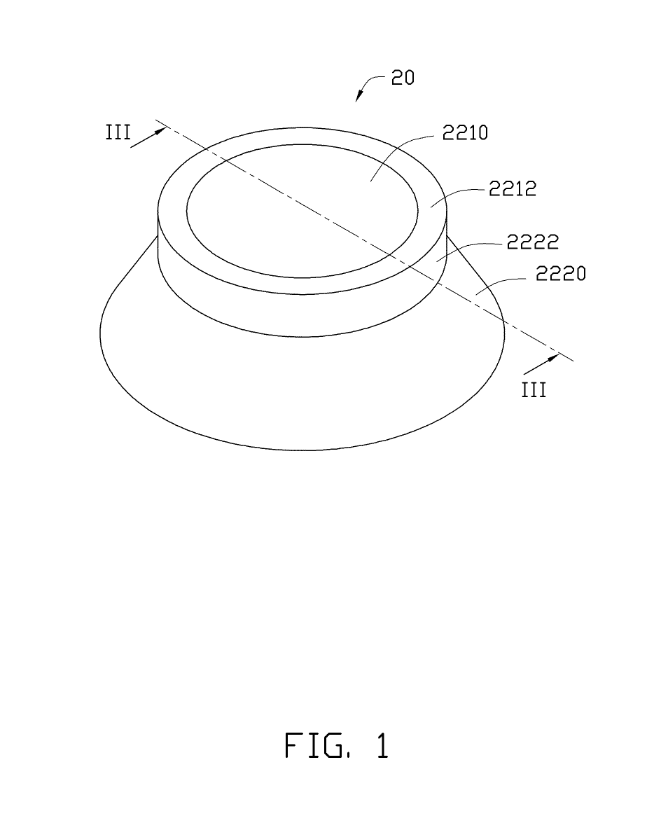

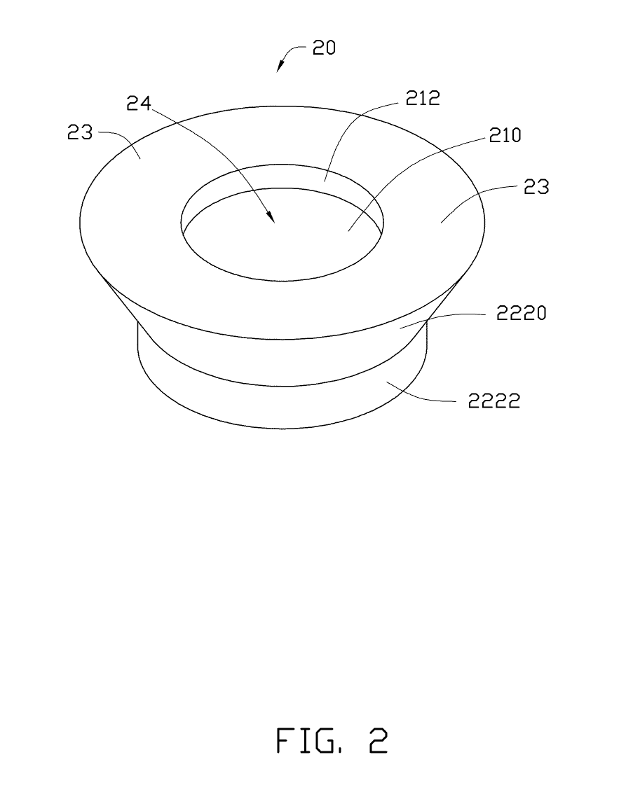

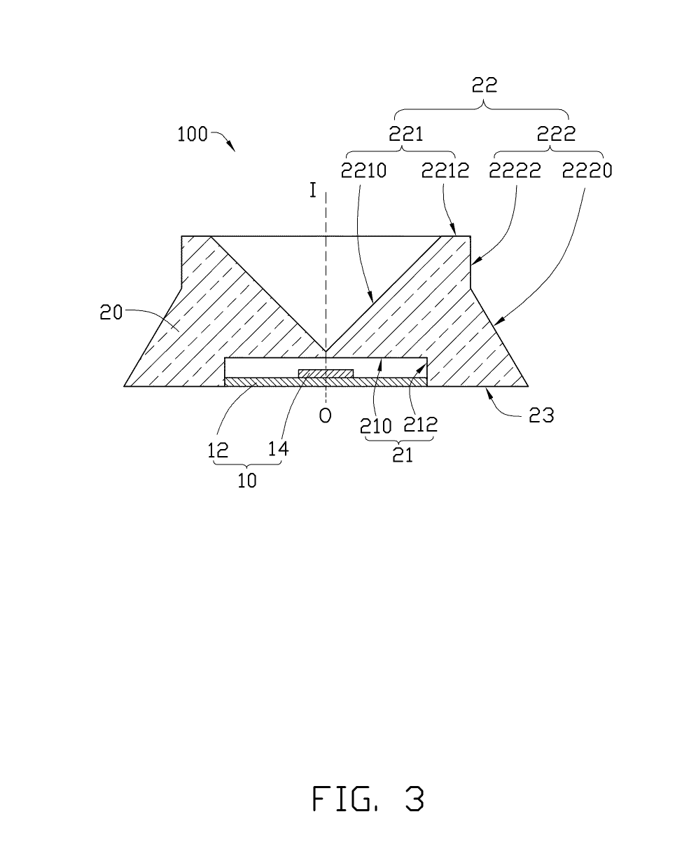

Referring to FIGS. 1 through 3, a light source module 100 in accordance with an exemplary embodiment of the disclosure is illustrated. The light source module 100 includes a light source 10 and an optical lens 20 covering the light source 10.

The optical lens 20 includes a light incident face 21 facing the light source 10, a light emitting face 22 opposite to the light incident face 21, and a connecting face 23 connecting the light incident face 21 and the light emitting face 22. The light source 10 has an optical axis O, around which light emitted from the light source 10 concentrates in a surrounding space.

In this embodiment of the present disclosure, the light source 10 is a light emitting diode (LED), and includes a supporting base 12 and an LED chip 14 mounted on the supporting base 12. The supporting base 12 is flat. The supporting base 12 may be made of electrically-insulating materials such as epoxy, silicon or ceramic. The LED chip 14 may be made of semiconductor materials such as GaN, InGaN, AlInGaN or the like. Preferably, the LED chip 14 emits visible light when being activated.

The optical lens 20 is integrally made of transparent materials such as PC (polycarbonate), PMMA (polymethyl methacrylate) or optical glass. It could be understood, a plurality of fluorescence, such as YAG, TAG, silicate, nitride, nitrogen oxides, phosphide, arsenide, telluride or sulfide, could be further provided to mix in the optical lens 20.

The optical lens 20 is located above and spaced from the light source 10. A center of a bottom face of the optical lens 20 is recessed inwardly, whereby the light incident face 21 and a receiving space 24 for accommodating the light source 10 are formed. The light incident face 21 includes a first light-incident facet 210 and a second light-incident facet 212. The first light-incident facet 210 is an inner face of the lens 20 which faces the light source 10 for the light emitted from the light source 10 with a small light-emergent angle passing through. The second light-incident facet 212 is another inner surface of the lens 20 surrounding the light source 10 for the light emitted from the light source 10 with a large light-emergent angle passing through. The first light-incident facet 210 is a planar face, and the second light-incident facet 212 is a cylindrical face. The connecting face 23 is an annular and planar face surrounding the light incident face 21. In use, the connecting face 23 is fitly attached on a supporting face (not shown) supporting the light source 10 and the optical lens 20.

The optical lens 20 defines a central axis I, and the optical lens 20 is axisymmetric relative to the central axis I. The central axis I of the optical lens 20 is aligned with the optical axis O of the light source 10. The light incident face 21 is axisymmetric relative to the central axis I. The light emitting face 22 is axisymmetric relative to the central axis I.

The light emitting face 22 includes a lateral face 222 extending upwardly from an outer periphery of the connecting face 23 and a top face 221 located above the light incident face 21. The top face 221 of the light emitting face 22 includes a center facet 2210 and a periphery facet 2212 surrounding and extending outwardly from the center facet 2210. A center of the top face 221 is recessed inwardly, whereby the center facet 2210 is formed. The center facet 2210 is a conical face. A diameter of the center facet 2210 gradually decreases along a top-to-bottom direction of the optical lens 20. The center facet 2210 is axisymmetric relative to the central axis I. In the embodiment of the present disclosure, the periphery facet 2212 is an annular and planar face. It could be understood that, the periphery facet 2212 can also be sculptured, ellipsoidal, spherical or paraboloidal. The periphery facet 2212 is axisymmetric relative to the central axis I. An outer periphery of the periphery facet 2212 of the top face 221 correspondingly intersects with that of the lateral face 222.

The lateral face 222 of the light emitting face 22 is a discontinuous face and includes a first lateral facet 2220 and a second lateral facet 2222 intersecting with the first lateral facet 2220. A bottom periphery of the first lateral facet 2220 correspondingly intersects with the outer periphery of the connecting face 23. In the embodiment of the present disclosure, the first lateral facet 2220 is a conical face. A diameter of the first lateral facet 2220 gradually decreases along the top-to-bottom direction of the optical lens 20. It could be understood that, the first lateral facet 2220 can also be cylindrical, sculptured, ellipsoidal, spherical or paraboloidal. The first lateral facet 2220 is axisymmetric relative to the central axis I. A top periphery of the second lateral facet 2222 correspondingly intersects with the outer periphery of the periphery facet 2212. In the embodiment of the present disclosure, the second lateral facet 2222 is a cylindrical face. It could be understood that, the second lateral facet 2222 can also be conical, sculptured, ellipsoidal, spherical or paraboloidal. The second lateral facet 2222 is axisymmetric relative to the central axis I.

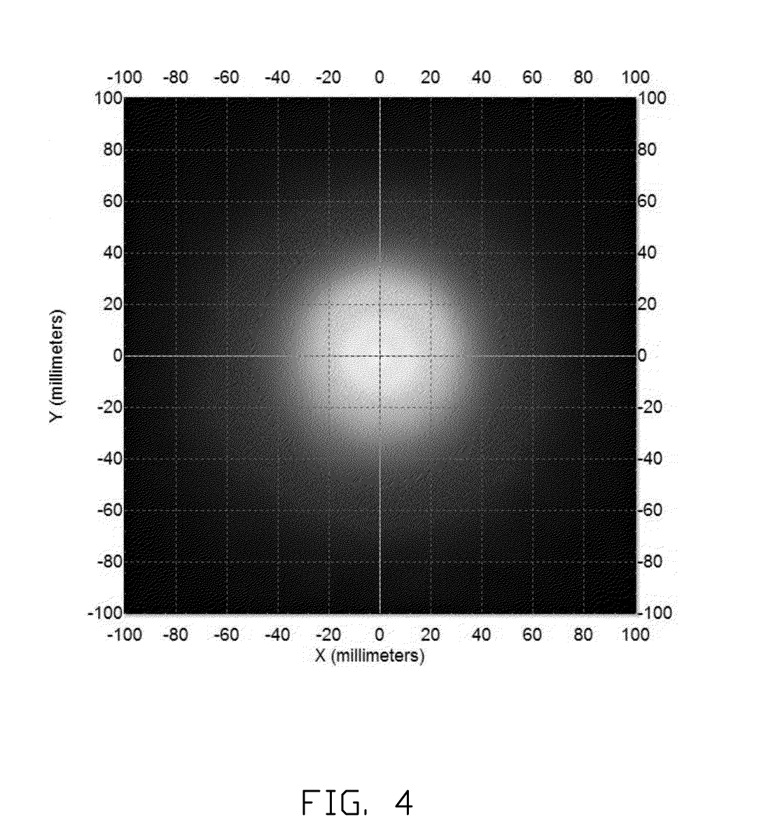

Referring to FIGS. 1 through 4, in use, the light emitted from the light source 10 is entered into the optical lens 20 through the first light-incident facet 210 and the second light-incident facet 212 of the light incident face 21 and refracted, then transmitted in the optical lens 20, and exited and refracted from the center facet 2210 and the periphery facet 2212 of the top face 221, and the first lateral facet 2220 and the second lateral facet 2222 of the lateral face 222, such that an illumination angle of the light source module 100 is widened and a satisfied light distribution of the light source module 100 is obtained.

It is to be further understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An optical lens for adjusting light emitted from a light source, comprising:
a light incident face facing the light source;
a light emitting face opposite to the light incident face; and
a connecting face connecting the light incident face and the light emitting face;
wherein the light emitting face comprises a lateral face extending upwardly from an outer periphery of the connecting face and a top face located above the light incident face;
wherein the top face of the light emitting face comprises a center facet and a periphery facet surrounding and extending outwardly from the center facet; and
wherein the center facet is recessed inwardly from a center of the top face of the light emitting face.

2. The optical lens as claimed in claim 1, wherein the center facet of the top face of the light emitting face is a conical face.

3. The optical lens as claimed in claim 1, wherein the periphery facet of the top face of the light emitting face is an annular and planar face.

4. The optical lens as claimed in claim 1, wherein the lateral face of the light emitting face is a discontinuous face and includes a first lateral facet and a second lateral facet intersecting with the first lateral facet, a bottom periphery of the first lateral facet correspondingly intersects with the outer periphery of the connecting face, and a top periphery of the second lateral facet correspondingly intersects with the outer periphery of the periphery facet.

5. The optical lens as claimed in claim 4, wherein the first lateral facet is a conical face.

6. The optical lens as claimed in claim 5, wherein a diameter of the first lateral facet gradually decreases along the top-to-bottom direction of the optical lens.

7. The optical lens as claimed in claim 4, wherein the second lateral facet is a cylindrical face.

8. The optical lens as claimed in claim 1, wherein the optical lens defines a central axis, and the optical lens is axisymmetric relative to the central axis.

9. The optical lens as claimed in claim 8, wherein the center facet of the top face of the light emitting face is axisymmetric relative to the central axis.

10. The optical lens as claimed in claim 8, wherein the light incident face is axisymmetric relative to the central axis, and the light emitting face is axisymmetric relative to the central axis.

11. A light source module, comprising:
a light source;
an optical lens covering the light source, and the optical lens comprising:
a light incident face facing the light source;
a light emitting face opposite to the light incident face; and
a connecting face connecting the light incident face and the light emitting face;
wherein the light emitting face comprises a lateral face extending upwardly from an outer periphery of the connecting face and a top face located above the light incident face;
wherein the top face of the light emitting face comprises a center facet and a periphery facet surrounding and extending outwardly from the center facet; and
wherein the center facet is recessed inwardly from a center of the top face of the light emitting face.

12. The light source module as claimed in claim 11, wherein the center facet of the top face of the light emitting face is a conical face.

13. The light source module as claimed in claim 11, wherein the periphery facet of the top face of the light emitting face is an annular and planar face.

14. The light source module as claimed in claim 11, wherein the lateral face of the light emitting face is a discontinuous face and includes a first lateral facet and a second lateral facet intersecting with the first lateral facet, a bottom periphery of the first lateral facet correspondingly intersects with the outer periphery of the connecting face, and a top periphery of the second lateral facet correspondingly intersects with the outer periphery of the periphery facet.

15. The light source module as claimed in claim 14, wherein the first lateral facet is a conical face.

16. The light source module as claimed in claim 15, wherein a diameter of the first lateral facet gradually decreases along the top-to-bottom direction of the optical lens.

17. The light source module as claimed in claim 14, wherein the second lateral facet is a cylindrical face.

18. The light source module as claimed in claim 11, wherein the optical lens defines a central axis, and the optical lens is axisymmetric relative to the central axis.

19. The light source module as claimed in claim 18, wherein the center facet of the top face of the light emitting face is axisymmetric relative to the central axis.

20. The light source module as claimed in claim 18, wherein the light incident is axisymmetric relative to the central axis, and the light emitting face is axisymmetric relative to the central axis.
